(19) United States
(12) Patent Application Publication
(10) Pub. No.: US 2026/0100531 A1
(43) Pub. Date: Apr. 9, 2026

(54) Connector Signal Transmission System and Cable-End Connector, Board-End Connector, and Connector Assembly Thereof

(71) Applicants: Tarng Yu Enterprise co., ltd., New Taipei City (TW); Dongguan Tarng Yu Electronics Co., Ltd., Dongguan City (CN)

(72) Inventors: YING-CHUNG CHEN, New Taipei City (TW); MU-JUNG HUANG, New Taipei City (TW)

(21) Appl. No.: 19/347,679

(22) Filed: Oct. 1, 2025

(30) Foreign Application Priority Data
Oct. 7, 2024 (TW) 113210829

(51) Int. Cl. H01R 12/79; H01R 12/70; H01R 12/71; H01R 13/631

(52) U.S. Cl. CPC H01R 12/79; H01R 12/7082; H01R 12/716; H01R 13/631

(57) ABSTRACT

A connector signal transmission system and cable-end connector, board-end connector, and connector assembly thereof. The cable-end connector is engaged with the board-end connector and comprises a cable-end effective engagement detection conductor. The cable-end effective engagement detection conductor is configured to detect whether the terminal sets of the cable-end connector and the board-end connector are effectively engaged. In this manner, the conventional technical problem in which the terminal sets of multiple connectors in a connector assembly may fail to transmit signals effectively due to incomplete engagement can be resolved, thereby allowing the connector assembly of the present application to transmit signals in a timely manner and to function as expected in electronic devices.

### CROSS-REFERENCE TO RELATED APPLICATIONS

This application claims the priority of Republic of China Patent Application No. 113210829 filed on Oct. 7, 2024, in the State Intellectual Property Office of the R.O.C., the disclosure of which is incorporated herein by reference.

### BACKGROUND OF THE INVENTION

### Field of the Invention

The present application relates to the technical field of electronic devices, and more particularly, to a connector signal transmission system capable of performing timely signal transmission, and a cable-end connector, a board-end connector, and a connector assembly thereof.

### Descriptions of the Related Art

Conventionally, a connector assembly is often required in an electronic device. Generally, a connector assembly is composed of a plurality of connectors, and these connectors are engaged with each other to transmit signals. However, in practical implementation, the connector assembly may not effectively transmit the signals if terminal sets of the connectors are not properly engaged. This causes the connector assembly to fail to perform as expected in the electronic device.

In view of the foregoing, how to prevent the terminal sets of the connectors of the connector assembly from transmitting signals before they are effectively engaged has become an urgent issue to be addressed by those skilled in the related art.

### SUMMARY OF THE INVENTION

In view of the drawbacks of the prior art mentioned above, the present application provides a cable-end connector comprising a first connector engaging side and a second connector engaging side, wherein the first connector engaging side and the second connector engaging side are substantially different sides, the cable-end connector comprising: a cable-end signal terminal set, comprising a first cable-end signal terminal and a second cable-end signal terminal; and a cable-end effective engagement detection conductor, comprising a first cable-end effective engagement detection conductor engaging structure and a second cable-end effective engagement detection conductor engaging structure; wherein, the first cable-end signal terminal and the first cable-end effective engagement detection conductor engaging structure are located at the first connector engaging side; and the second cable-end signal terminal and the second cable-end effective engagement detection conductor engaging structure are located at the second connector engaging side.

Preferably, the cable-end connector said above, wherein the first cable-end effective engagement detection conductor engaging structure and the second cable-end effective engagement detection conductor engaging structure are plate-shaped structures.

Preferably, the cable-end connector said above, wherein the cable-end effective engagement detection conductor is extended to both the first connector engaging side and the second connector engaging side, such that the first cable-end effective engagement detection conductor engaging structure is located at the first connector engaging side, and the second cable-end effective engagement detection conductor engaging structure is located at the second connector engaging side.

Preferably, the cable-end connector said above, wherein the cable-end effective engagement detection conductor is a metallic shell.

Preferably, the cable-end connector said above, wherein the cable-end signal terminal set is located between the first cable-end effective engagement detection conductor engaging structure and the second cable-end effective engagement detection conductor engaging structure.

Additionally, the present application provides board-end connector comprising a first connector engaging side and a second connector engaging side, wherein the first connector engaging side and the second connector engaging side are substantially different sides, the board-end connector comprising: a board-end signal terminal set, comprising a first board-end signal terminal and a second board-end signal terminal; and a board-end effective engagement detection component set, comprising a first board-end effective engagement detection component and a second board-end effective engagement detection component; wherein, the first board-end signal terminal and the first board-end effective engagement detection component are located at the first connector engaging side; and the second board-end signal terminal and the second board-end effective engagement detection component are located at the second connector engaging side.

Preferably, the board-end connector said above, wherein the board-end signal terminal set is located between the first board-end effective engagement detection component and the second board-end effective engagement detection component.

Additionally, the present application provides a connector assembly comprising a first connector engaging side and a second connector engaging side, wherein the first connector engaging side and the second connector engaging side are substantially different sides, the connector assembly comprising: a board-end connector, comprising: a board-end signal terminal set, comprising a first board-end signal terminal and a second board-end signal terminal; and a board-end effective engagement detection component set, comprising a first board-end effective engagement detection component and a second board-end effective engagement detection component; and a cable-end connector configured to engage with the board-end connector and comprising: a cable-end signal terminal set, comprising a first cable-end signal terminal and a second cable-end signal terminal; and a cable-end effective engagement detection conductor; wherein, during engagement of the cable-end connector and the board-end connector, the cable-end signal terminal set is configured to engage with the board-end signal terminal set, such that the first cable-end signal terminal engages with the first board-end signal terminal at the first connector engaging side, and the second cable-end signal terminal engages with the second board-end signal terminal at the second connector engaging side, and the cable-end effective engagement detection conductor is configured to engage with the board-end effective engagement detection component set, such that the cable-end effective engagement detection conductor engages with the first board-end effective engagement detection component at the first connector engaging side and engages with the second board-end effective engagement detection component at the second connector engaging side.

Preferably, the connector assembly said above, wherein the first board-end signal terminal and the second board-end signal terminal are blade-type terminals; and the first cable-end signal terminal and the second cable-end signal terminal are clamp arm terminals.

Preferably, the connector assembly said above, wherein the cable-end effective engagement detection conductor comprises a first cable-end effective engagement detection conductor engaging structure and a second cable-end effective engagement detection conductor engaging structure; wherein, during engagement of the cable-end effective engagement detection conductor and the board-end effective engagement detection component set, the first cable-end effective engagement detection conductor engaging structure is engaged with the first board-end effective engagement detection component at the first connector engaging side, and the second cable-end effective engagement detection conductor engaging structure is engaged with the second board-end effective engagement detection component at the second connector engaging side, wherein the first cable-end effective engagement detection conductor engaging structure and the second cable-end effective engagement detection conductor engaging structure are plate-shaped structures.

Preferably, the connector assembly said above, wherein the first board-end effective engagement detection component comprises a first board-end effective engagement detection component engaging structure, and the second board-end effective engagement detection component comprises a second board-end effective engagement detection component engaging structure, and during engagement of the cable-end effective engagement detection conductor and the board-end effective engagement detection component set, the first cable-end effective engagement detection conductor is engaged with the first board-end effective engagement detection component engaging structure, and the second cable-end effective engagement detection conductor is engaged with the second board-end effective engagement detection component engaging structure, wherein the first board-end effective engagement detection component engaging structure and the second board-end effective engagement detection component engaging structure are elastic arm engaging structures.

Additionally, the present application provides a connector signal transmission system comprising a first connector engaging side and a second connector engaging side, wherein the first connector engaging side and the second connector engaging side are substantially different sides, the connector signal transmission system comprising: a circuit board, comprising a signal transmission module, the signal transmission module being configured to transmit a first terminal signal and a second terminal signal; and a connector assembly, comprising a board-end connector and a cable-end connector, wherein the board-end connector is disposed on the circuit board and comprises: a board-end signal terminal set electrically connected to the circuit board, the board-end signal terminal set comprising a first board-end signal terminal and a second board-end signal terminal; and a board-end effective engagement detection component set electrically connected to the circuit board, the board-end effective engagement detection component set comprising a first board-end effective engagement detection component and a second board-end effective engagement detection component; and the cable-end connector is configured to engage with the board-end connector at the first connector engaging side and the second connector engaging side, and the cable-end connector comprises: a cable-end signal terminal set, comprising a first cable-end signal terminal and a second cable-end signal terminal; and a cable-end effective engagement detection conductor, comprising a first cable-end effective engagement detection conductor engaging structure and a second cable-end effective engagement detection conductor engaging structure; wherein, during engagement of the cable-end connector and the board-end connector, the cable-end signal terminal set is configured to engages with the board-end signal terminal set during a first time period, such that the first cable-end signal terminal engages with the first board-end signal terminal at the first connector engaging side, and the second cable-end signal terminal engages with the second board-end signal terminal at the second connector engaging side, and the cable-end effective engagement detection conductor is configured to engages with the board-end effective engagement detection component set during a second time period, such that the first cable-end effective engagement detection conductor engaging structure engages with the first board-end effective engagement detection component at the first connector engaging side, and the second cable-end effective engagement detection conductor engaging structure engages with the second board-end effective engagement detection component at the second connector engaging side, wherein the first time period is earlier than the second time period; and the signal transmission module is configured to detect whether the cable-end effective engagement detection conductor is engaged with the board-end effective engagement detection component set, and when the cable-end effective engagement detection conductor is engaged with the board-end effective engagement detection component set, the cable-end signal terminal set is effectively engaged with the board-end signal terminal set, such that the signal transmission module transmits the first terminal signal from the first board-end signal terminal to the first cable-end signal terminal, and transmits the second terminal signal from the second board-end signal terminal to the second cable-end signal terminal.

Preferably, the connector signal transmission system said above, wherein the cable-end effective engagement detection conductor further comprises a first cable-end effective engagement detection conductor locking structure and a second cable-end effective engagement detection conductor locking structure, and when the cable-end signal terminal set is effectively engaged with the board-end signal terminal set, the first cable-end effective engagement detection conductor locking structure is locked to the board-end connector at the first connector engaging side, and the second cable-end effective engagement detection conductor locking structure is locked to the board-end connector at the second connector engaging side, so as to prevent the engaged state between the cable-end signal terminal set and the board-end signal terminal set from being released.

Preferably, the connector signal transmission system said above, wherein the board-end connector further comprises a board-end force-bearing member set, and the board-end force-bearing member set comprises a first board-end force-bearing member and a second board-end force-bearing member, wherein the first board-end force-bearing member comprises a first board-end force-bearing member locking structure, and the second board-end force-bearing member comprises a second board-end force-bearing member locking structure; and when the cable-end signal terminal set is effectively engaged with the board-end signal terminal set, the first board-end force-bearing member locking structure is locked to the cable-end connector at the first connector engaging side, and the second board-end force-bearing member locking structure is locked to the cable-end connector at the second connector engaging side, so as to prevent the engaged state between the cable-end signal terminal set and the board-end signal terminal set from being released.

In comparison with prior art, the present application provides a connector signal transmission system and cable-end connector, board-end connector, and connector assembly thereof. The cable-end connector is engaged with the board-end connector and comprises a cable-end effective engagement detection conductor. Correspondingly, the board-end connector comprises a board-end effective engagement detection component set. During engagement of the cable-end connector with the board-end connector, the cable-end effective engagement detection conductor is engaged with the board-end effective engagement detection component set so as to detect whether engagement of the terminal sets between the cable-end connector and the board-end connector is in place. Accordingly, the technical issue in conventional connector assemblies, wherein multiple connectors may fail to effectively transmit signals due to incomplete engagement of the terminal sets can be resolved, allowing the connector assembly of the present application to transmit signals in a timely manner and thereby perform as expected in electronic devices.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective schematic view of a connector signal transmission system of the present application according to one embodiment.

FIG. 2 is a perspective schematic view of a connector assembly of the present application according to one embodiment.

FIG. 3 is a top schematic view of the connector assembly of the present application according to one embodiment.

FIG. 4 is a cross-sectional schematic view of a portion of the connector assembly shown in FIG. 3 taken along line AA.

FIG. 5 is a cross-sectional schematic view of a portion of the connector assembly shown in FIG. 3 taken along line A′A′.

FIG. 6 is a front schematic view of a portion of the connector assembly of the present application according to one embodiment.

FIG. 7 is a perspective schematic view of a portion of the connector assembly of the present application according to one embodiment.

FIG. 8 is a front schematic view of a portion of the connector assembly of the present application according to one embodiment.

FIG. 9 is a perspective schematic view of a portion of the connector assembly of the present application according to one embodiment.

FIG. 10 is a perspective schematic view of a board-end connector of the present application according to one embodiment.

FIG. 11 is a perspective schematic view of a cable-end connector of the present application according to one embodiment.

FIG. 12 is a flowchart illustrating a connector signal transmission method according to one embodiment of the present application.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

Additionally, it should be noted that, for the sake of clarity and conciseness in the disclosure, the same reference numerals will be used in the following embodiments to denote components comprising identical or similar functions, and descriptions of identical or equivalent features will be omitted.

The present application provides a connector signal transmission system, and a cable-end connector, a board-end connector, and a connector assembly thereof. The cable-end connector is engaged with the board-end connector, and the cable-end connector comprises a cable-end effective engagement detection conductor, which is configured to detect whether the terminal sets of the cable-end connector and the board-end connector are effectively engaged. In this manner, the technical problem that the terminal sets of multiple connectors of a conventional connector assembly fail to effectively transmit signals due to incomplete engagement can be resolved, thereby enabling the connector assembly of the present application to transmit signals in a timely manner and perform its intended function in an electronic device.

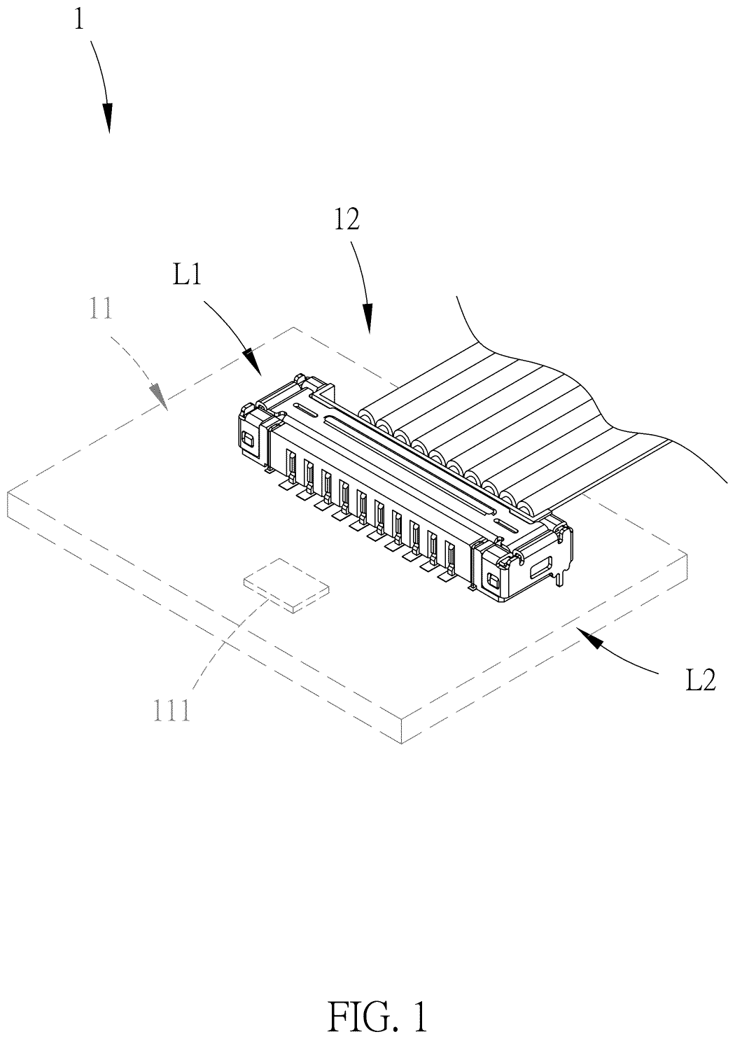

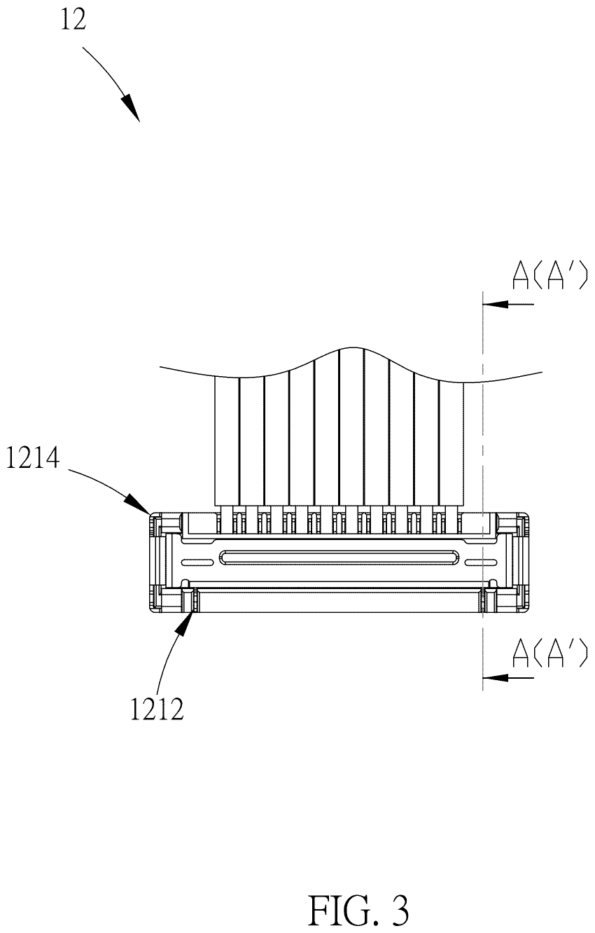

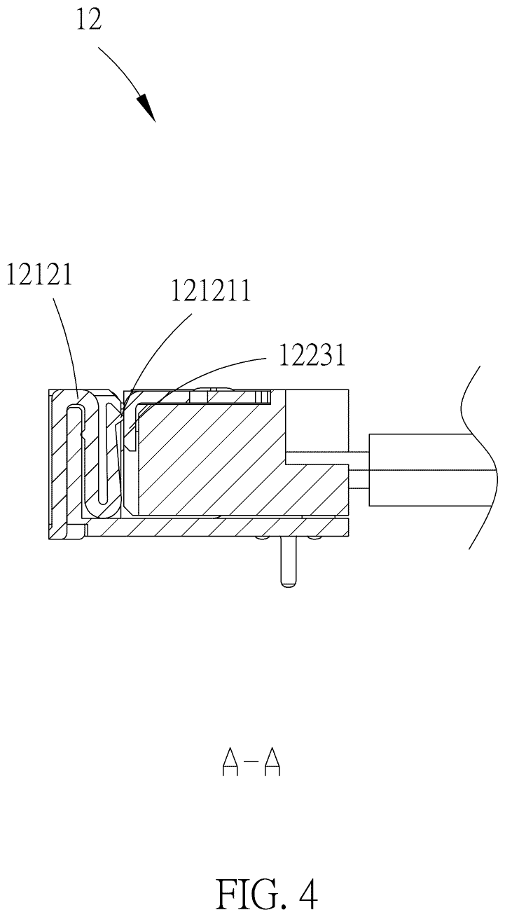

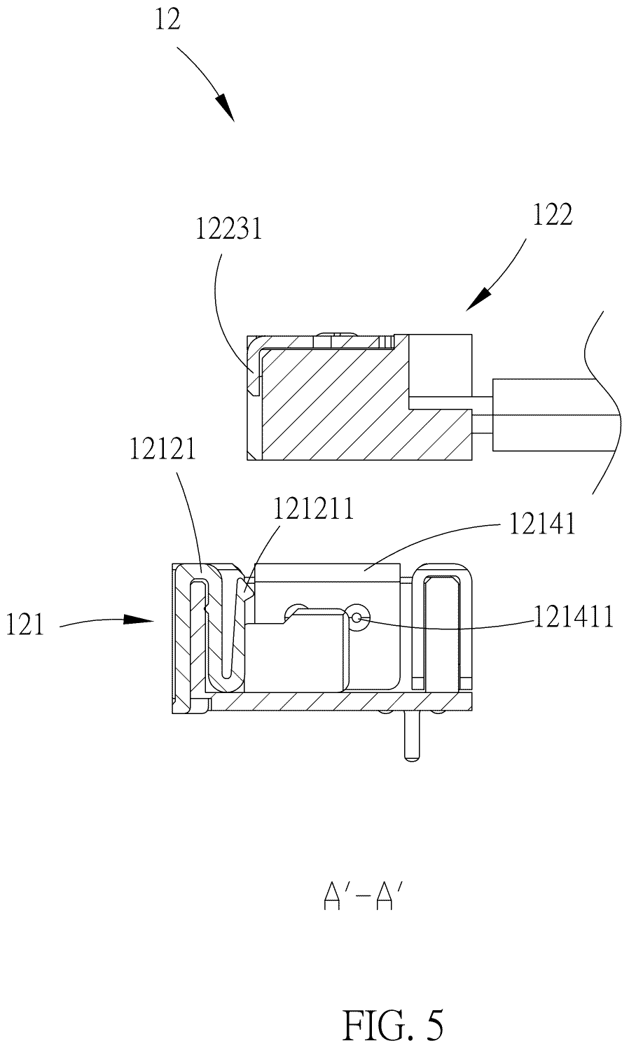

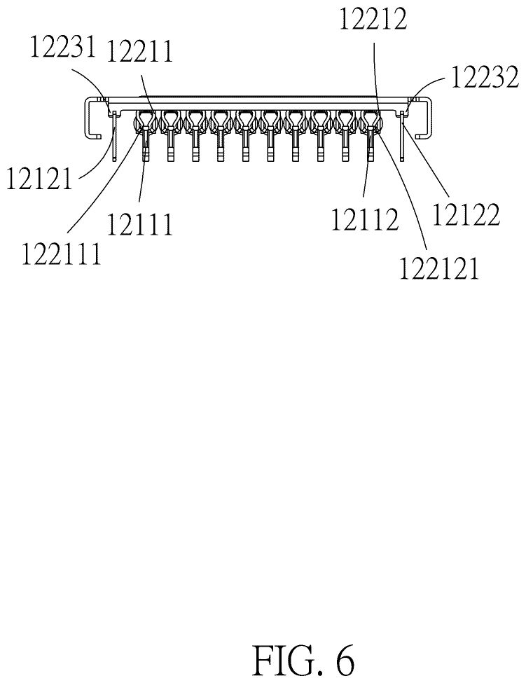

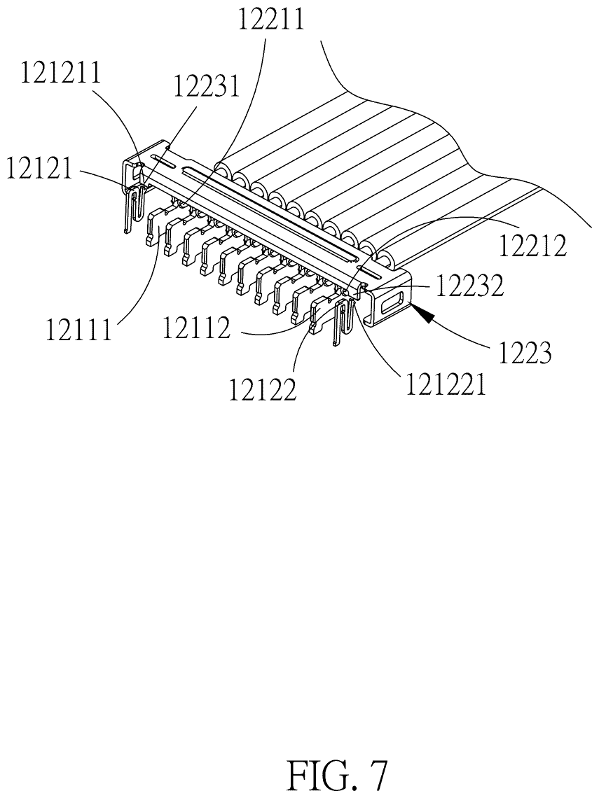

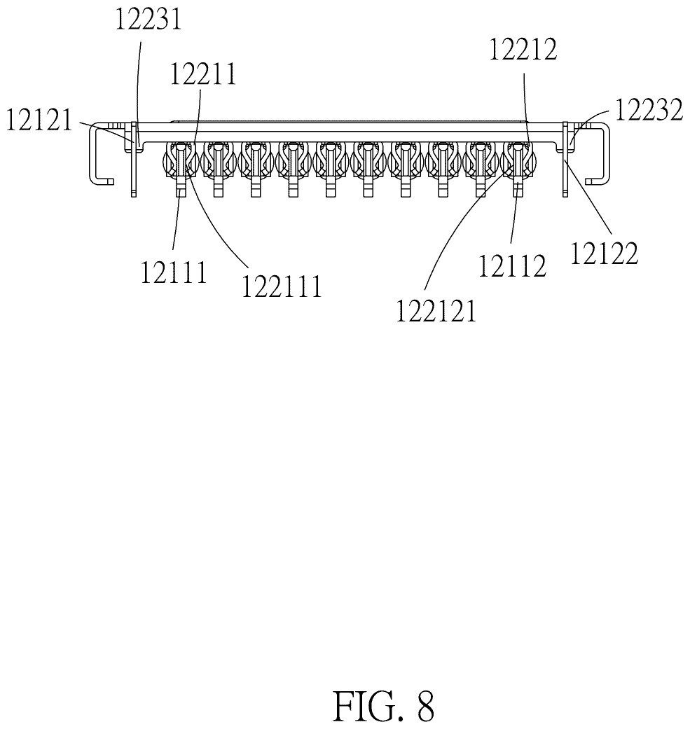

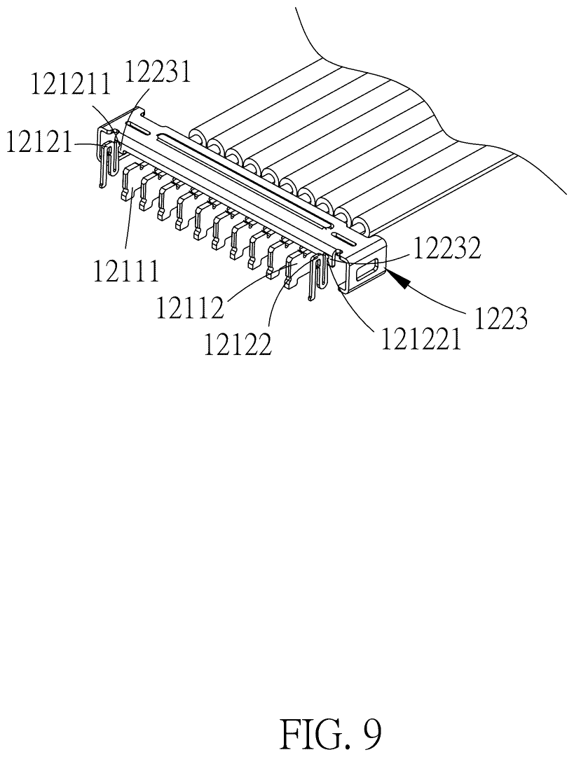

For a detailed description of the embodiments disclosed in the present application, please refer to FIGS. 1 to 12.

In the embodiments shown in FIGS. 1 to 12, a connector signal transmission system 1 is disclosed. The connector signal transmission system 1 comprises: a circuit board 11 and a connector assembly 12.

With respect to the circuit board 11, the circuit board 11 comprises a signal transmission module 111, wherein the signal transmission module 111 is configured to transmit a first terminal signal and a second terminal signal. It should be noted that the first terminal signal and the second terminal signal may be electric power signals or digital signals.

With respect to the connector assembly 12, the connector assembly 12 comprises a board-end connector 121 and a cable-end connector 122. In the above-described embodiment, the board-end connector 121 is disposed on the circuit board 11 to transmit signals. Accordingly, the cable-end connector 122 is engaged with the board-end connector 121 respectively at a first connector engaging side L1 and a second connector engaging side L2. As such, the circuit board 11 is able to transmit signals to the cable-end connector 122 via the board-end connector 121. It should be noted that the first connector engaging side L1 and the second connector engaging side L2 are substantially different sides. Optionally, the first connector engaging side L1 and the second connector engaging side L2 may be opposite sides; for example, the first connector engaging side L1 is a left side, and the second connector engaging side L2 is a right side.

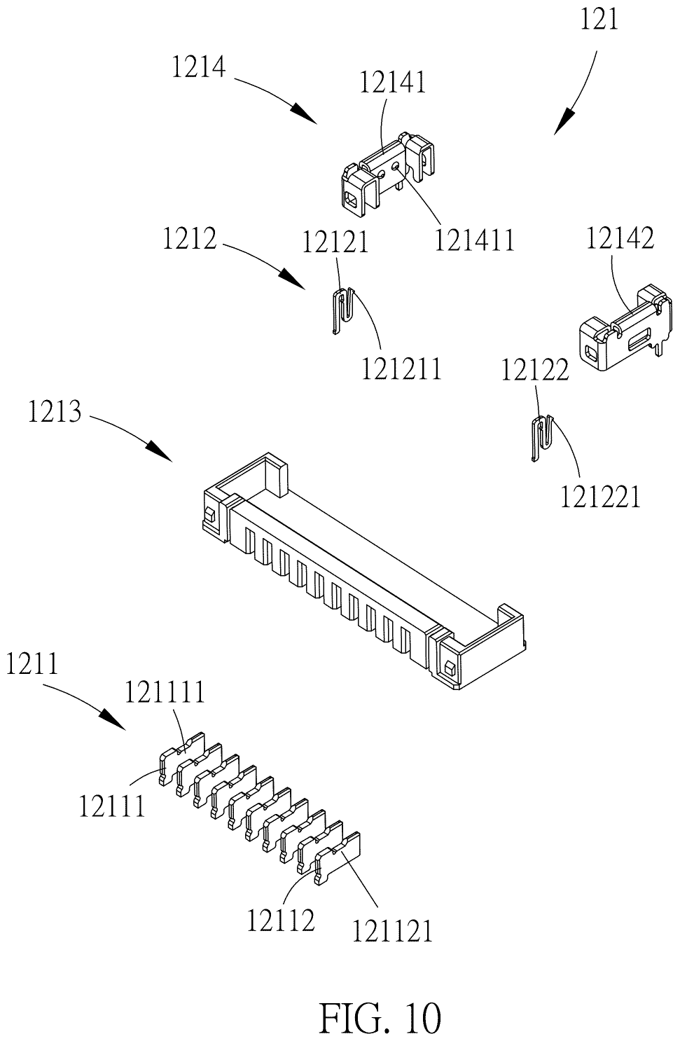

In the embodiment shown in FIG. 10, the board-end connector 121 comprises: a board-end signal terminal set 1211, a board-end effective engagement detection component set 1212, and a board-end insulating core 1213.

With respect to the board-end signal terminal set 1211, the board-end signal terminal set 1211 comprises a first board-end signal terminal 12111 and a second board-end signal terminal 12112. When the board-end connector 121 is disposed on the circuit board 11, the board-end signal terminal set 1211 is electrically connected to the circuit board 11. Furthermore, the first board-end signal terminal 12111 comprises a first board-end signal terminal engaging structure 121111, and the second board-end signal terminal 12112 comprises a second board-end signal terminal engaging structure 121121.

With respect to the board-end effective engagement detection component set 1212, the board-end effective engagement detection component set 1212 comprises a first board-end effective engagement detection component 12121 and a second board-end effective engagement detection component 12122. When the board-end connector 121 is disposed on the circuit board 11, the board-end effective engagement detection component set 1212 is electrically connected to the circuit board 11. Furthermore, the first board-end effective engagement detection component 12121 comprises a first board-end effective engagement detection component engaging structure 121211, and the second board-end effective engagement detection component 12122 comprises a second board-end effective engagement detection component engaging structure 121221.

With respect to the board-end insulating core 1213, the board-end insulating core 1213 is engaged with the board-end signal terminal set 1211 and the board-end effective engagement detection component set 1212, such that the first board-end signal terminal engaging structure 121111 and the second board-end signal terminal engaging structure 121121 are respectively located at the first connector engaging side L1 and the second connector engaging side L2, and the first board-end effective engagement detection component engaging structure 121211 and the second board-end effective engagement detection component engaging structure 121221 are also respectively located at the first connector engaging side L1 and the second connector engaging side L2.

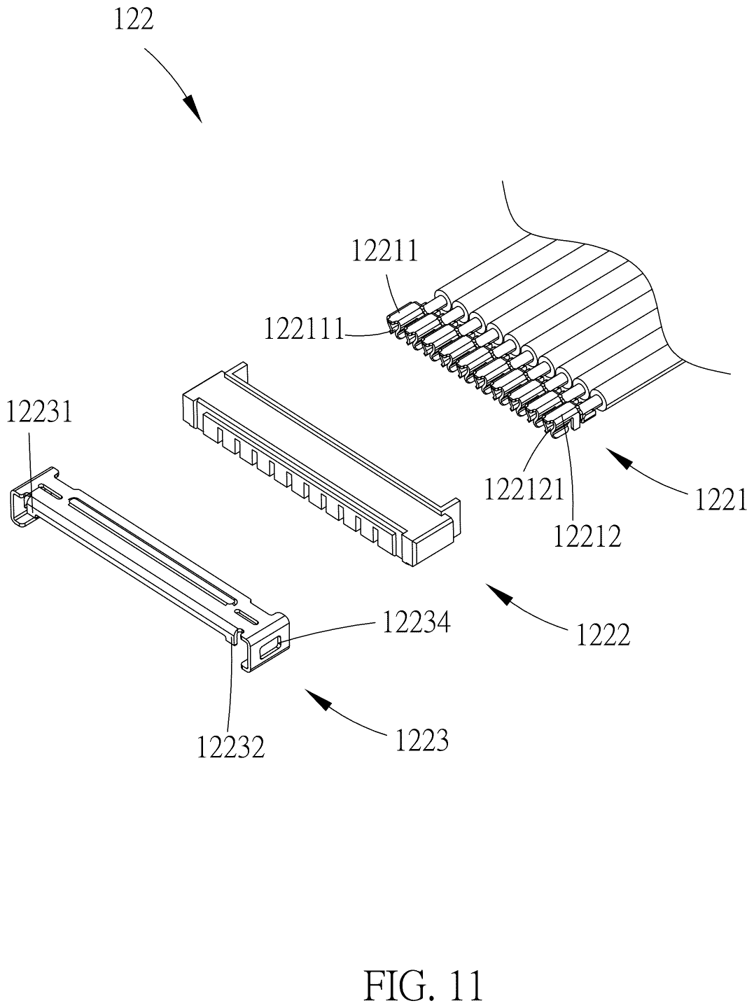

In the embodiment shown in FIG. 11, the cable-end connector 122 comprises: a cable-end signal terminal set 1221, a cable-end insulating core 1222, and a cable-end effective engagement detection conductor 1223.

With respect to the cable-end signal terminal set 1221, the cable-end signal terminal set 1221 comprises a first cable-end signal terminal 12211 and a second cable-end signal terminal 12212. Furthermore, the first cable-end signal terminal 12211 comprises a first cable-end signal terminal engaging structure 122111, and the second cable-end signal terminal 12212 comprises a second cable-end signal terminal engaging structure 122121.

With respect to the cable-end insulating core 1222, the cable-end insulating core 1222 is configured to engage the cable-end signal terminal set 1221, so that the first cable-end signal terminal engaging structure 122111 is located at the first connector engaging side L1, and the second cable-end signal terminal engaging structure 122121 is located at the second connector engaging side L2.

With respect to the cable-end effective engagement detection conductor 1223, the cable-end effective engagement detection conductor 1223 comprises a first cable-end effective engagement detection conductor engaging structure 12231 and a second cable-end effective engagement detection conductor engaging structure 12232. It should be noted that the cable-end effective engagement detection conductor 1223 is configured to engage the cable-end insulating core 1222, and the cable-end effective engagement detection conductor 1223 respectively is extended to the first connector engaging side L1 and the second connector engaging side L2, so that the first cable-end effective engagement detection conductor engaging structure 12231 is located at the first connector engaging side L1, and the second cable-end effective engagement detection conductor engaging structure 12232 is located at the second connector engaging side L2.

Optionally, the cable-end effective engagement detection conductor 1223 is a metallic shell or a conductor configured to transmit a detection signal.

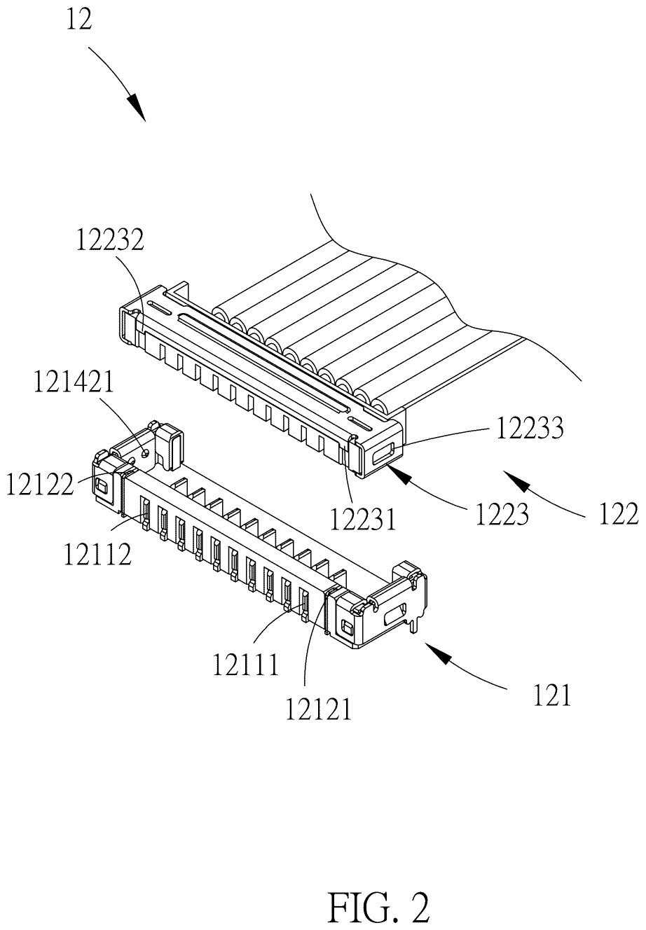

In the embodiments shown in FIGS. 2 and 6 to 10, the first board-end signal terminal 12111 and the second board-end signal terminal 12112 are blade-type terminals. Accordingly, the first cable-end signal terminal 12211 and the second cable-end signal terminal 12212 are clamp-arm-type terminals. However, it should be noted that in the present application, the first board-end signal terminal 12111 and the second board-end signal terminal 12112 are not limited to blade-type terminals, and the first cable-end signal terminal 12211 and the second cable-end signal terminal 12212 are not limited to clamp-arm-type terminals.

During the engagement process of the cable-end connector 122 with the board-end connector 121, the cable-end signal terminal set 1221 is engaged with the board-end signal terminal set 1211 in a first time period, so that the first cable-end signal terminal engaging structure 122111 (i.e., the first cable-end signal terminal 12211) is coupled to the first board-end signal terminal engaging structure 121111 (i.e., the first board-end signal terminal 12111) at the first connector engaging side L1, and the second cable-end signal terminal engaging structure 122121 (i.e., the second cable-end signal terminal 12212) is coupled to the second board-end signal terminal engaging structure 121121 (i.e., the second board-end signal terminal 12112) at the second connector engaging side L2. Furthermore, the cable-end effective engagement detection conductor 1223 is engaged with the board-end effective engagement detection component set 1212 in a second time period, so that the first cable-end effective engagement detection conductor engaging structure 12231 (i.e., the cable-end effective engagement detection conductor 1223) engages with the first board-end effective engagement detection component engaging structure 121211 (i.e., the first board-end effective engagement detection component 12121) at the first connector engaging side L1, and the second cable-end effective engagement detection conductor engaging structure 12232 (i.e., the cable-end effective engagement detection conductor 1223) engages with the second board-end effective engagement detection component engaging structure 121221 (i.e., the second board-end effective engagement detection component 12122) at the second connector engaging side L2.

It should be noted that the first time period is earlier than the second time period. Therefore, the engagement of the cable-end signal terminal set 1221 with the board-end signal terminal set 1211 occurs before the engagement of the cable-end effective engagement detection conductor 1223 with the board-end effective engagement detection component set 1212. That is, when the cable-end effective engagement detection conductor 1223 engages with the board-end effective engagement detection component set 1212, the cable-end signal terminal set 1221 comprises already been effectively engaged with the board-end signal terminal set 1211, such that the first cable-end signal terminal 12211 has completed engagement with the first board-end signal terminal 12111, and the second cable-end signal terminal 12212 has completed engagement with the second board-end signal terminal 12112. In this manner, the signal transmission module 111 can stably transmit the first terminal signal from the first board-end signal terminal 12111 to the first cable-end signal terminal 12211, and transmit the second terminal signal from the second board-end signal terminal 12112 to the second cable-end signal terminal 12212, enabling the connector assembly 12 to achieve expected signal transmission in various electronic devices, thereby solving the technical problem in the prior art that the terminal sets of multiple connectors of a connector assembly may fail to transmit signals effectively due to incomplete engagement.

In the above embodiment, the board-end signal terminal set 1211 is located between the first board-end effective engagement detection component 12121 and the second board-end effective engagement detection component 12122. In this manner, the first time period for the cable-end signal terminal set 1221 to engage the board-end signal terminal set 1211 is earlier than the second time period for the cable-end effective engagement detection conductor 1223 to engage the board-end effective engagement detection component set 1212.

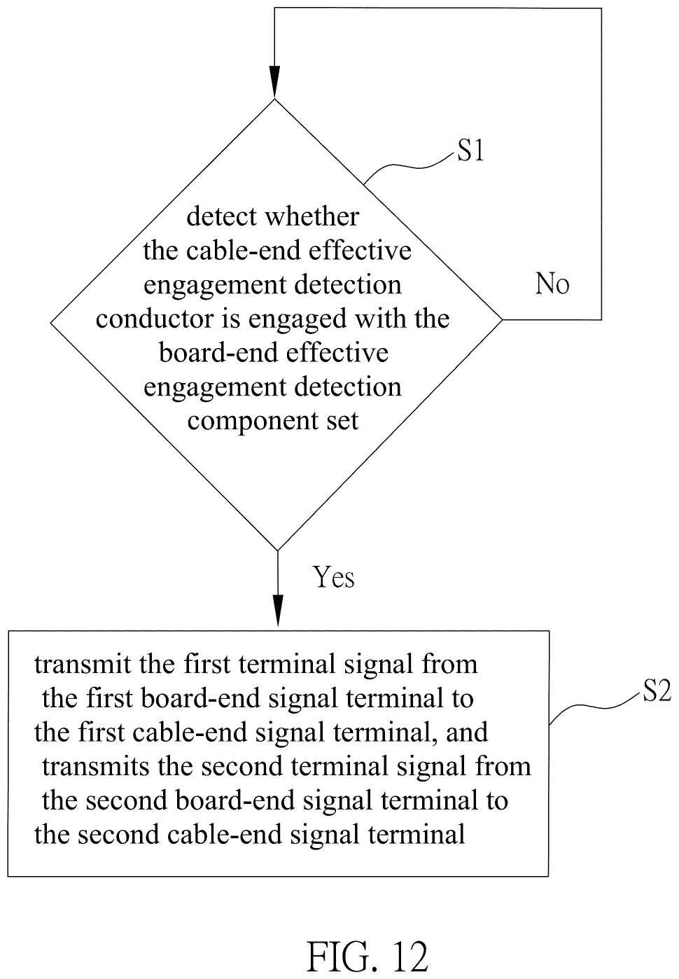

It should be noted that, with respect to the connector signal transmission method, during the engagement process of the cable-end connector 122 with the board-end connector 121, in step S1 shown in FIG. 12, the signal transmission module 111 is configured to detect whether the cable-end effective engagement detection conductor 1223 engages with the board-end effective engagement detection component set 1212. In step S2 shown in FIG. 12, when the cable-end effective engagement detection conductor 1223 engages with the board-end effective engagement detection component set 1212, this indicates that the cable-end connector 122 is effectively engaged with the board-end connector 121, that is, the cable-end signal terminal set 1221 is effectively engaged with the board-end signal terminal set 1211. Thereafter, the signal transmission module 111 transmits the first terminal signal from the first board-end signal terminal 12111 to the first cable-end signal terminal 12211, and transmits the second terminal signal from the second board-end signal terminal 12112 to the second cable-end signal terminal 12212.

Therefore, in the implementation of the connector signal transmission system 1, the signal transmission module 111 does not transmit the first terminal signal and the second terminal signal until the cable-end signal terminal set 1221 is effectively engaged with the board-end signal terminal set 1211. In this way, the connector assembly 12 can stably transmit the first terminal signal and the second terminal signal, enabling the connector assembly 12 to achieve expected signal transmission in various electronic devices, thereby solving the technical problem in the prior art that the terminal sets of multiple connectors of a connector assembly may fail to transmit signals effectively due to incomplete engagement.

In the embodiments shown in FIGS. 2 and 4 to 10, the first cable-end effective engagement detection conductor engaging structure 12231 and the second cable-end effective engagement detection conductor engaging structure 12232 are plate-shaped structures. Accordingly, the first board-end effective engagement detection component engaging structure 121211 is an elastic arm engaging structure configured to elastically engage the first cable-end effective engagement detection conductor engaging structure 12231 (i.e., the cable-end effective engagement detection conductor 1223), and the second board-end effective engagement detection component engaging structure 121221 is an elastic arm engaging structure configured to elastically engage the second cable-end effective engagement detection conductor engaging structure 12232 (i.e., the cable-end effective engagement detection conductor 1223). In this manner, the engagement between the cable-end effective engagement detection conductor 1223 (i.e., the first cable-end effective engagement detection conductor engaging structure 12231 and the second cable-end effective engagement detection conductor engaging structure 12232) and the first board-end effective engagement detection component 12121 and the second board-end effective engagement detection component 12122, respectively, meets the intended expectations. However, it should be noted that, in the present application, the first cable-end effective engagement detection conductor engaging structure 12231 and the second cable-end effective engagement detection conductor engaging structure 12232 are not limited to plate-shaped structures, and the first board-end effective engagement detection component engaging structure 121211 and the second board-end effective engagement detection component engaging structure 121221 are not limited to elastic arm engaging structures.

In the embodiments shown in FIGS. 2, 5, and 10, the board-end connector 121 further comprises: a board-end force-bearing member set 1214, the board-end force-bearing member set 1214 comprises a first board-end force-bearing member 12141 and a second board-end force-bearing member 12142. The first board-end force-bearing member 12141 and the second board-end force-bearing member 12142 respectively comprise, for example, a protruded structure as a first board-end force-bearing member locking structure 121411 and a second board-end force-bearing member locking structure 121421. Furthermore, the board-end insulating core 1213 is further engaged with the board-end force-bearing member set 1214, so that the first board-end force-bearing member locking structure 121411 is located at the first connector engaging side L1, and the second board-end force-bearing member locking structure 121421 is located at the second connector engaging side L2.

It should be noted that when the cable-end signal terminal set 1221 is effectively engaged with the board-end signal terminal set 1211, the first board-end force-bearing member locking structure 121411 and the second board-end force-bearing member locking structure 121421 are configured to respectively lock the cable-end connector 122 in place. In this way, the engagement between the cable-end signal terminal set 1221 and the board-end signal terminal set 1211 can be maintained, and even prevent the cable-end connector 122 from easily detaching from the board-end connector 121.

It should be noted that, in the embodiment shown in FIG. 1, the first board-end force-bearing member 12141 and the second board-end force-bearing member 12142 are configured to respectively connect to the circuit board 11, thereby positioning the board-end connector 121 on the circuit board 11.

In the embodiments shown in FIGS. 2, 5, and 10, the cable-end effective engagement detection conductor 1223 further comprises a first cable-end effective engagement detection conductor locking structure 12233 and a second cable-end effective engagement detection conductor locking structure 12234. The first cable-end effective engagement detection conductor locking structure 12233 and the second cable-end effective engagement detection conductor locking structure 12234 are respectively located at the first connector engaging side L1 and the second connector engaging side L2.

It should be noted that when the cable-end signal terminal set 1221 is effectively engaged with the board-end signal terminal set 1211, the first cable-end effective engagement detection conductor locking structure 12233 and the second cable-end effective engagement detection conductor locking structure 12234 are configured to respectively lock to the board-end connector 121 at the first connector engaging side L1 and the second connector engaging side L2. In this way, the engagement between the cable-end signal terminal set 1221 and the board-end signal terminal set 1211 can be maintained, and even prevent the cable-end connector 122 from easily detaching from the board-end connector 121.

It should be noted that the connector signal transmission system of the present application, as well as the cable-end connector, the board-end connector, and the connector assembly thereof, may omit certain components and are not limited to the above-described embodiments.

For example, the cable-end connector of the present application may optionally comprise only: a cable-end signal terminal set and a cable-end effective engagement detection conductor. The cable-end signal terminal set comprises a first cable-end signal terminal and a second cable-end signal terminal. The cable-end effective engagement detection conductor comprises a first cable-end effective engagement detection conductor engaging structure and a second cable-end effective engagement detection conductor engaging structure; wherein, the first cable-end signal terminal and the first cable-end effective engagement detection conductor engaging structure are located at a first connector engaging side; the second cable-end signal terminal and the second cable-end effective engagement detection conductor engaging structure are located at a second connector engaging side; and the first connector engaging side and the second connector engaging side are substantially different sides.

Additionally, the board-end connector of the present application may optionally comprise only: a board-end signal terminal set and a board-end effective engagement detection component set. The board-end signal terminal set comprises a first board-end signal terminal and a second board-end signal terminal. The board-end effective engagement detection component set comprises a first board-end effective engagement detection component and a second board-end effective engagement detection component; wherein, the first board-end signal terminal and the first board-end effective engagement detection component are located at a first connector engaging side; the second board-end signal terminal and the second board-end effective engagement detection component are located at a second connector engaging side; and the first connector engaging side and the second connector engaging side are substantially different sides.

Furthermore, the connector assembly of the present application may optionally comprise only: a board-end connector and a cable-end connector. The board-end connector comprises: a board-end signal terminal set and a board-end effective engagement detection component set; the board-end signal terminal set comprises a first board-end signal terminal and a second board-end signal terminal; the board-end effective engagement detection component set comprises a first board-end effective engagement detection component and a second board-end effective engagement detection component. The cable-end connector is engaged with the board-end connector and comprises: a cable-end signal terminal set and a cable-end effective engagement detection conductor. The cable-end signal terminal set comprises a first cable-end signal terminal and a second cable-end signal terminal. During the engagement process of the cable-end connector with the board-end connector, the cable-end signal terminal set is engaged with the board-end signal terminal set, such that the first cable-end signal terminal engages with the first board-end signal terminal at a first connector engaging side, and the second cable-end signal terminal engages with the second board-end signal terminal at a second connector engaging side; and the cable-end effective engagement detection conductor is engaged with the board-end effective engagement detection component set, such that the cable-end effective engagement detection conductor engages with the first board-end effective engagement detection component at the first connector engaging side, and engages with the second board-end effective engagement detection component at the second connector engaging side; and the first connector engaging side and the second connector engaging side are substantially different sides.

Moreover, the connector signal transmission system of the present application may optionally comprise only: a circuit board and a connector assembly. The circuit board comprises a signal transmission module, and the signal transmission module is configured to transmit a first terminal signal and a second terminal signal. The connector assembly comprises a board-end connector and a cable-end connector, wherein the board-end connector is disposed on the circuit board and comprises: a board-end signal terminal set and a board-end effective engagement detection component set. The board-end signal terminal set is electrically connected to the circuit board and comprises a first board-end signal terminal and a second board-end signal terminal. The board-end effective engagement detection component set is electrically connected to the circuit board and comprises a first board-end effective engagement detection component and a second board-end effective engagement detection component. The cable-end connector is engaged with the board-end connector at a first connector engaging side and a second connector engaging side, and the cable-end connector comprises: a cable-end signal terminal set and a cable-end effective engagement detection conductor. The cable-end signal terminal set comprises a first cable-end signal terminal and a second cable-end signal terminal. The cable-end effective engagement detection conductor comprises a first cable-end effective engagement detection conductor engaging structure and a second cable-end effective engagement detection conductor engaging structure. During the engagement process of the cable-end connector with the board-end connector, the cable-end signal terminal set engages with the board-end signal terminal set in a first time period, so that the first cable-end signal terminal is coupled to the first board-end signal terminal at the first connector engaging side, and the second cable-end signal terminal is coupled to the second board-end signal terminal at the second connector engaging side; and the cable-end effective engagement detection conductor engages with the board-end effective engagement detection component set in a second time period, so that the first cable-end effective engagement detection conductor engaging structure engages with the first board-end effective engagement detection component at the first connector engaging side, and the second cable-end effective engagement detection conductor engaging structure engages with the second board-end effective engagement detection component at the second connector engaging side, wherein the first time period is earlier than the second time period; and the signal transmission module is configured to detect whether the cable-end effective engagement detection conductor engages with the board-end effective engagement detection component set. When the cable-end effective engagement detection conductor engages with the board-end effective engagement detection component set, the cable-end signal terminal set is effectively engaged with the board-end signal terminal set. Thereafter, the signal transmission module transmits the first terminal signal from the first board-end signal terminal to the first cable-end signal terminal, and transmits the second terminal signal from the second board-end signal terminal to the second cable-end signal terminal.

In summary, the present application provides a connector signal transmission system and a cable-end connector, a board-end connector, and a connector assembly thereof. The cable-end connector is engaged with the board-end connector and comprises a cable-end effective engagement detection conductor. Correspondingly, the board-end connector comprises a board-end effective engagement detection component set. During the engagement process of the cable-end connector with the board-end connector, the cable-end effective engagement detection conductor is engaged with the board-end effective engagement detection component set to detect whether the terminal sets of the cable-end connector and the board-end connector are effectively engaged. In this way, the technical problem in the prior art that the terminal sets of multiple connectors of a connector assembly may fail to transmit signals effectively due to incomplete engagement can be resolved, thereby enabling the connector assembly of the present application to transmit signals in a timely manner and perform its intended function in electronic devices.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. A cable-end connector comprising a first connector engaging side and a second connector engaging side, wherein the first connector engaging side and the second connector engaging side are substantially different sides, the cable-end connector comprising:
a cable-end signal terminal set, comprising a first cable-end signal terminal and a second cable-end signal terminal; and
a cable-end effective engagement detection conductor, comprising a first cable-end effective engagement detection conductor engaging structure and a second cable-end effective engagement detection conductor engaging structure; wherein,
the first cable-end signal terminal and the first cable-end effective engagement detection conductor engaging structure are located at the first connector engaging side; and
the second cable-end signal terminal and the second cable-end effective engagement detection conductor engaging structure are located at the second connector engaging side.

2. The cable-end connector of claim 1, wherein the first cable-end effective engagement detection conductor engaging structure and the second cable-end effective engagement detection conductor engaging structure are plate-shaped structures.

3. The cable-end connector of claim 1, wherein the cable-end effective engagement detection conductor is extended to both the first connector engaging side and the second connector engaging side, such that the first cable-end effective engagement detection conductor engaging structure is located at the first connector engaging side, and the second cable-end effective engagement detection conductor engaging structure is located at the second connector engaging side.

4. The cable-end connector of claim 1, wherein the cable-end effective engagement detection conductor is a metallic shell.

5. The cable-end connector of claim 1, wherein the cable-end signal terminal set is located between the first cable-end effective engagement detection conductor engaging structure and the second cable-end effective engagement detection conductor engaging structure.

6. A board-end connector comprising a first connector engaging side and a second connector engaging side, wherein the first connector engaging side and the second connector engaging side are substantially different sides, the board-end connector comprising:
a board-end signal terminal set, comprising a first board-end signal terminal and a second board-end signal terminal; and
a board-end effective engagement detection component set, comprising a first board-end effective engagement detection component and a second board-end effective engagement detection component; wherein,
the first board-end signal terminal and the first board-end effective engagement detection component are located at the first connector engaging side; and
the second board-end signal terminal and the second board-end effective engagement detection component are located at the second connector engaging side.

7. The board-end connector of claim 6, wherein the board-end signal terminal set is located between the first board-end effective engagement detection component and the second board-end effective engagement detection component.

8. A connector assembly comprising a first connector engaging side and a second connector engaging side, wherein the first connector engaging side and the second connector engaging side are substantially different sides, the connector assembly comprising:
a board-end connector, comprising:
a board-end signal terminal set, comprising a first board-end signal terminal and a second board-end signal terminal; and
a board-end effective engagement detection component set, comprising a first board-end effective engagement detection component and a second board-end effective engagement detection component; and
a cable-end connector configured to engage with the board-end connector and comprising:
a cable-end signal terminal set, comprising a first cable-end signal terminal and a second cable-end signal terminal; and
a cable-end effective engagement detection conductor; wherein,
during engagement of the cable-end connector and the board-end connector, the cable-end signal terminal set is configured to engage with the board-end signal terminal set, such that the first cable-end signal terminal engages with the first board-end signal terminal at the first connector engaging side, and the second cable-end signal terminal engages with the second board-end signal terminal at the second connector engaging side, and the cable-end effective engagement detection conductor is configured to engage with the board-end effective engagement detection component set, such that the cable-end effective engagement detection conductor engages with the first board-end effective engagement detection component at the first connector engaging side and engages with the second board-end effective engagement detection component at the second connector engaging side.

9. The connector assembly of claim 8, wherein the first board-end signal terminal and the second board-end signal terminal are blade-type terminals; and the first cable-end signal terminal and the second cable-end signal terminal are clamp arm terminals.

10. The connector assembly of claim 8, wherein the cable-end effective engagement detection conductor comprises a first cable-end effective engagement detection conductor engaging structure and a second cable-end effective engagement detection conductor engaging structure;
wherein, during engagement of the cable-end effective engagement detection conductor and the board-end effective engagement detection component set, the first cable-end effective engagement detection conductor engaging structure is engaged with the first board-end effective engagement detection component at the first connector engaging side, and the second cable-end effective engagement detection conductor engaging structure is engaged with the second board-end effective engagement detection component at the second connector engaging side, wherein the first cable-end effective engagement detection conductor engaging structure and the second cable-end effective engagement detection conductor engaging structure are plate-shaped structures.

11. The connector assembly of claim 8, wherein the first board-end effective engagement detection component comprises a first board-end effective engagement detection component engaging structure, and the second board-end effective engagement detection component comprises a second board-end effective engagement detection component engaging structure, and during engagement of the cable-end effective engagement detection conductor and the board-end effective engagement detection component set, the first cable-end effective engagement detection conductor is engaged with the first board-end effective engagement detection component engaging structure, and the second cable-end effective engagement detection conductor is engaged with the second board-end effective engagement detection component engaging structure, wherein the first board-end effective engagement detection component engaging structure and the second board-end effective engagement detection component engaging structure are elastic arm engaging structures.

12. A connector signal transmission system comprising a first connector engaging side and a second connector engaging side, wherein the first connector engaging side and the second connector engaging side are substantially different sides, the connector signal transmission system comprising:
a circuit board, comprising a signal transmission module, the signal transmission module being configured to transmit a first terminal signal and a second terminal signal; and
a connector assembly, comprising a board-end connector and a cable-end connector, wherein
the board-end connector is disposed on the circuit board and comprises:
a board-end signal terminal set electrically connected to the circuit board, the board-end signal terminal set comprising a first board-end signal terminal and a second board-end signal terminal; and
a board-end effective engagement detection component set electrically connected to the circuit board, the board-end effective engagement detection component set comprising a first board-end effective engagement detection component and a second board-end effective engagement detection component; and
the cable-end connector is configured to engage with the board-end connector at the first connector engaging side and the second connector engaging side, and the cable-end connector comprises:
a cable-end signal terminal set, comprising a first cable-end signal terminal and a second cable-end signal terminal; and
a cable-end effective engagement detection conductor, comprising a first cable-end effective engagement detection conductor engaging structure and a second cable-end effective engagement detection conductor engaging structure; wherein,
during engagement of the cable-end connector and the board-end connector, the cable-end signal terminal set is configured to engages with the board-end signal terminal set during a first time period, such that the first cable-end signal terminal engages with the first board-end signal terminal at the first connector engaging side, and the second cable-end signal terminal engages with the second board-end signal terminal at the second connector engaging side, and the cable-end effective engagement detection conductor is configured to engages with the board-end effective engagement detection component set during a second time period, such that the first cable-end effective engagement detection conductor engaging structure engages with the first board-end effective engagement detection component at the first connector engaging side, and the second cable-end effective engagement detection conductor engaging structure engages with the second board-end effective engagement detection component at the second connector engaging side, wherein the first time period is earlier than the second time period; and the signal transmission module is configured to detect whether the cable-end effective engagement detection conductor is engaged with the board-end effective engagement detection component set, and when the cable-end effective engagement detection conductor is engaged with the board-end effective engagement detection component set, the cable-end signal terminal set is effectively engaged with the board-end signal terminal set, such that the signal transmission module transmits the first terminal signal from the first board-end signal terminal to the first cable-end signal terminal, and transmits the second terminal signal from the second board-end signal terminal to the second cable-end signal terminal.

13. The connector signal transmission system of claim 12, wherein the cable-end effective engagement detection conductor further comprises a first cable-end effective engagement detection conductor locking structure and a second cable-end effective engagement detection conductor locking structure, and when the cable-end signal terminal set is effectively engaged with the board-end signal terminal set, the first cable-end effective engagement detection conductor locking structure is locked to the board-end connector at the first connector engaging side, and the second cable-end effective engagement detection conductor locking structure is locked to the board-end connector at the second connector engaging side, so as to prevent the engaged state between the cable-end signal terminal set and the board-end signal terminal set from being released.

14. The connector signal transmission system of claim 12, wherein the board-end connector further comprises a board-end force-bearing member set, and the board-end force-bearing member set comprises a first board-end force-bearing member and a second board-end force-bearing member, wherein the first board-end force-bearing member comprises a first board-end force-bearing member locking structure, and the second board-end force-bearing member comprises a second board-end force-bearing member locking structure; and when the cable-end signal terminal set is effectively engaged with the board-end signal terminal set, the first board-end force-bearing member locking structure is locked to the cable-end connector at the first connector engaging side, and the second board-end force-bearing member locking structure is locked to the cable-end connector at the second connector engaging side, so as to prevent the engaged state between the cable-end signal terminal set and the board-end signal terminal set from being released.
